(19) United States
(12) Patent Application Publication
(10) Pub. No.: US 2026/0201789 A1
(43) Pub. Date: Jul. 16, 2026

(54) LOGGING TOOLS THAT INCLUDE A DISTRIBUTED TENSOR RESISTIVITY LOGGING SYSTEM AND PROCESSES FOR ASSEMBLING AND USING SAME

(71) Applicant: SCHLUMBERGER TECHNOLOGY CORPORATION, Sugar Land, TX (US)

(72) Inventors: Julien TONIOLO, Katy, TX (US); Dean HOMAN, Sugarland, TX (US); Mark Frey, SugarLand, TX (US); Olivier MOYAL, SugarLand, TX (US); Khaled Hadj SASSI, Clamart (FR)

(21) Appl. No.: 19/134,714

(22) PCT Filed: Dec. 4, 2023
(86) PCT No.: PCT/US2023/082327

§ 371 Date: May 31, 2025

Related U.S. Application Data
(60) Provisional application No. 63/385,794, filed on Dec. 2, 2022.
(60) Provisional application No. 63/476,322, filed on Dec. 20, 2022.

(51) Int. Cl. E21B 47/002; G01V 1/44; G01V 5/04

(52) U.S. Cl. CPC E21B 47/0025; G01V 1/44; G01V 5/04

(57) ABSTRACT

Logging tools for through the drill string conveyance that include a distributed tensor resistivity logging tool and processes for assembling and using same. In some embodiments, the distributed tensor resistivity logging tool can include at least one transmitter module, at least one receiver module, and at least three additional modules connected to one another, wherein at least one of the three additional modules is located between the at least one transmitter module and the at least one receiver module.

### CROSS-REFERENCE TO RELATED APPLICATIONS

The present application is an International Application that claims priority to U.S. Provisional Ser. No. 63/385,794 that was filed on Dec. 2, 2022, and U.S. Provisional Ser. No. 63/476,322 that was filed on Dec. 20, 2022, which are herein incorporated by reference in their entirety.

### FIELD

Embodiments described generally relate to downhole logging tools. More particularly, such embodiments relate to logging tools for through the drill string conveyance that include a distributed tensor resistivity logging system and processes for assembling and using same.

### BACKGROUND

The challenge of cost-effectively conveying downhole logging tools in long horizontal wells has been solved with the introduction of through the drill string conveyance. Through the drill string conveyance includes inserting a tool string that includes logging tools in the drill string having a sufficiently small diameter and, if necessary, pumping the tool string down with drilling rig pumps to provide supplemental downward force when gravity alone is insufficient to completely displace the tool string. The logging operation occurs on memory and battery power when the rig trips the drill string. The tool string can land and remain in the drill string or extend through and past the drill bit. It is typical for such tool strings to be approximately 200 ft long. The tool string can also be conveyed with more standard conveyance techniques, e.g., gravity assisted wireline, tractors, or coiled tubing.

There has been a demand for the ability to evaluate formation properties far from the borehole where the logging operation occurs. Such evaluations can include the detection of water fronts, formation modelling, and fluid mapping. Such evaluations are typical to “while drilling equipment” that inherently has no structural length limitations. Such while drilling equipment typically utilize resistivity tools that transmit and receive electrical fields, where the transmitters and receivers can be collocated on the same collar, or spread along the drill string, with spacing between them, in order to vary the depth of investigation. Existing through the drill string conveyance systems have the advantage of utilizing smaller diameter tools that can have a relatively low mass per linear foot of tool string as compared to the larger logging tools incorporated into the drill string and a stronger tether compared to traditional wireline cables. The existing through the drill string conveyance systems, however, lack the space needed to perform evaluation on formation properties far from the borehole where the logging operation occurs.

There is a need, therefore, for improved small diameter distributed tensor resistivity logging tools for through the drill string conveyance.

### SUMMARY

Logging tools for through the drill string conveyance that include a distributed tensor resistivity logging tool and processes for assembling and using same are provided. In some embodiments, the distributed tensor resistivity logging tool can include at least one transmitter module, at least one receiver module, and at least three additional modules connected to one another. At least one of the three additional modules can be located between the at least one transmitter module and the at least one receiver module.

In some embodiments, a process for conveying a distributed tensor resistivity logging tool into a borehole can include conveying the distributed tensor resistivity logging tool into a drill string located within the borehole. The distributed tensor resistivity logging tool can include at least one transmitter module, at least one receiver module, and at least three additional modules connected to one another. At least one of the three additional modules can be located between the at least one transmitter module and the at least one receiver module.

In some embodiments, a process for assembling a distributed tensor resistivity logging tool can include serially connecting a plurality of modules to form a distributed tensor resistivity logging tool. The distributed tensor resistivity logging tool can include at least one transmitter module, at least one receiver module, and at least three additional modules connected to one another. At least one of the three additional modules can be located between the at least one transmitter module and the at least one receiver module.

In some embodiments, the distributed tensor resistivity logging tool can include a plurality of modules serially connected to one another. The plurality of modules can include a transmitter module, a receiver module, and a plurality of additional modules. At least one of the plurality of additional modules can be located between the transmitter module and the receiver module.

A process for conveying a distributed tensor resistivity logging tool into a borehole can include conveying the distributed tensor resistivity logging tool into a drill string located within the borehole. The distributed tensor resistivity logging tool can include a plurality of modules serially connected to one another. The plurality of modules can include a transmitter module, a receiver module, and a plurality of additional modules. At least one of the plurality of additional modules can be located between the transmitter module and the receiver module.

A process for assembling a distributed tensor resistivity logging tool can include serially connecting a plurality of modules to form a distributed tensor resistivity logging tool. The distributed tensor resistivity logging tool can include a plurality of modules serially connected to one another. The plurality of modules can include a transmitter module, a receiver module, and a plurality of additional modules. At least one of the plurality of additional modules can be located between the transmitter module and the receiver module.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are, therefore, not to be considered limiting of its scope, for the invention may admit to other equally effective embodiments. It is emphasized that the figures are not necessarily to scale and certain features and certain views of the figures can be shown exaggerated in scale or in schematic for clarity and/or conciseness.

FIG. 1 depicts an illustrative transmitter module that can be incorporated into a tool string to form part of a distributed tensor resistivity logging system in a logging tool used for through the drill string conveyance, according to one or more embodiments described.

FIG. 2 depicts an illustrative receiver module that can be incorporated into a tool string to form part of a distributed tensor resistivity logging system in a logging tool used for though the drill string conveyance, according to one or more embodiments described.

FIG. 3 depicts an illustrative logging tool for through the drill string conveyance that includes a distributed tensor resistivity logging system, according to one or more embodiments described.

FIG. 4 depicts another illustrative logging tool for through the drill string conveyance that includes a distributed tensor resistivity logging system, according to one or more embodiments described.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Furthermore, in the following discussion and in the claims, the terms “including” and “comprising” are used in an open-ended fashion, and thus should be interpreted to mean “including, but not limited to.”

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

Unless otherwise indicated herein, all numerical values are “about” or “approximately” the indicated value, meaning the values take into account experimental error, machine tolerances and other variations that would be expected by a person having ordinary skill in the art. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions, and examples, but the inventions are not limited to these embodiments, versions or examples, which are included to enable a person having ordinary skill in the art to make and use the inventions, when the information in this disclosure is combined with publicly available information and technology.

FIG. 1 depicts an illustrative transmitter module 100 that can be incorporated into a tool string to form part of a distributed tensor resistivity logging system in a logging tool used for through the drill string conveyance, according to one or more embodiments. The transmitter module 100 can include components such as, but not limited to, an upper non-rotary field joint 101; a lower non-rotary field joint 102, a power supply, energy storage, communication, and transmitter electronics unit 103, and one or more antennas 104. The transmitter module 100 can also include a tool string bus 105 that can be configured to provide power and/or communication to and/or from the transmitter module 100. In some embodiments, the antenna 104 can include one, two, three, or more of (i) axial, (ii) transverse, and/or (iii) titled antennas axial, transverse, and/or titled antennas.

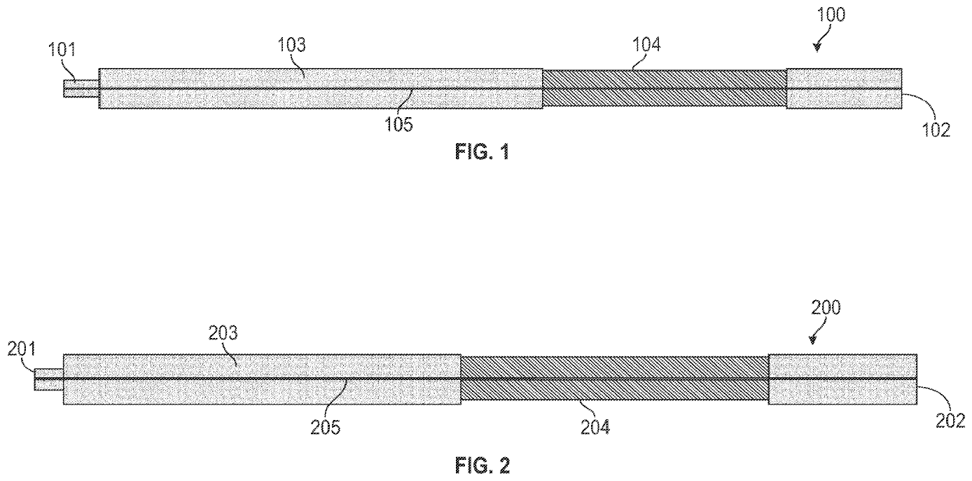

FIG. 2 depicts an illustrative receiver module 200 that can be incorporated into a tool string to form part of a distributed tensor resistivity logging system in a logging tool used for through the drill string conveyance, according to one or more embodiments. The receiver module 200 can include components such as, but not limited to, an upper non-rotary field joint 201; a lower non-rotary field joint 202, a power supply, energy storage, communication, and transmitter electronics unit 203, and one or more antennas 204. The receiver module 200 can also include a tool string bus 205 that can be configured to provide power and/or communication to and/or from the transmitter module 200. In some embodiments, the antenna 204 can include one, two, three, or more of (i) axial, (ii) transverse, and/or (iii) titled antennas.

Electromagnetic logging tools commonly use axial, transverse, and/or tilted antennas. An axial antenna can have a dipole moment that can be substantially parallel with the longitudinal axis of the tool. Axial antennas are commonly wound about the circumference of the tool such that the plane of the antenna can be orthogonal to the tool axis. Axial antennas can produce a radiation pattern that can be equivalent to a dipole along the axis of the tool (by convention the z direction). A transverse antenna can have a dipole moment that can be substantially perpendicular to the longitudinal axis of the tool. A transverse antenna can include a saddle coil (e.g., as disclosed in U.S. Patent Application Publications 2011/0074427 and 2011/0238312) and can generate a radiation pattern that can be equivalent to a dipole that can be perpendicular to the axis of the tool (by convention the x or y direction). A tilted antenna can have a dipole moment that can be neither parallel nor perpendicular to the longitudinal axis of the tool. Tilted antennas can generate a mixed mode radiation pattern (i.e., a radiation pattern in which the dipole moment can be neither parallel nor perpendicular with the tool axis).

In some embodiments, the transmitter module 100 and/or the receiver module 200 can include a collocated triaxial antenna arrangement. Such a triaxial antenna arrangement can include two or three antennas (e.g., two or three distinct antenna coils) that can be arranged to be mutually independent from one another. By mutually independent it is meant that the dipole moment of any one of the antennas does not lie in a plane formed by the dipole moments of the other antennas. Three tilted antennas can be one type of a triaxial antenna sensor. Three collocated orthogonal antennas, with one antenna axial and the other two transverse, can be another type of a triaxial antenna sensor.

As is known to those of ordinary skill in the art, a time varying electric current (an alternating current) in a transmitting antenna produces a corresponding time varying magnetic field in the local environment (e.g., the tool collar and the formation). The magnetic field in turn induces electrical currents (eddy currents) in the conductive formation. These eddy currents further produce secondary magnetic fields which may produce a voltage response in a receiving antenna. The measured voltage, or full tensor voltage, in the receiving antennae can be processed, as is known to those of ordinary skill in the art, to obtain one or more properties of the formation. For example, in some embodiments, the full tensor voltage in the receiving antennae can be processed as disclosed in U.S. Patent Application Publication No. 2016/0195634, in order to obtain one or more full tensor quantities.

In some embodiments, the tool string bus 105 of the transmitter module 100 and/or the tool string bus 205 of the receiver module 200 can transfer power and electronic communication through the transmitter module 100 and/or receiver module 100 to one or more additional modules. In a preferred embodiment, transmitter module(s) 100, receiver module(s) 200, and additional module(s) can transfer power and electronic communications through the transmitter module(s) 100 and receiver module(s) 200 to all other additional module(s).

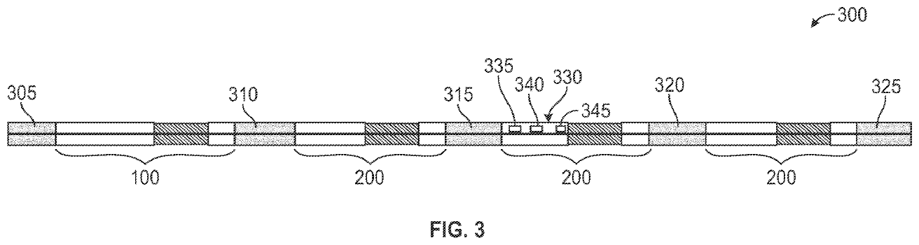

FIG. 3 depicts an illustrative distributed tensor resistivity logging tool 300 for through the drill string conveyance, according to one or more embodiments described. As shown, one or more transmitter modules (one is shown 100) and one or more receiver modules (three are shown 200) can be interspaced between and connected to one or more other or additional modules (five are shown 305, 310, 315, 320, and 325). The other additional modules 305, 310, 315, 320, and 325 can be different modules configured to carry out different operations than the transmitter module and the receiver module. The one or more transmitter modules 100 and the one or more receiver modules 200 can be connected to the other logging tools in new designs as well as added or spliced into existing designs. The location of the one or more transmitter modules 100 and the one or more receiver modules 200 along the logging tool 300, and with respect to the other modules 305, 310, 315, 320, and 325 present in the logging tool 300, can be based, at least in part, on the power, centralization, depth of investigation requirements of the logging tool 300, other engineering considerations, or any combination thereof.

In some embodiments, the logging tool 300 can include at least one transmitter module 100, at least one receiver module 200, and at least one other or additional module, e.g., 310, where the at least one additional module can be located between the transmitter module 100 and the receiver module 200. In some embodiments, at least one of the one or more other or additional modules 305, 310, 315, 320, and 325 can be located between two transmitter modules 100, between two receiver modules 200, or between a transmitter module 100 and a receiver module 200 such that the transmitter module(s) 100 and receiver module(s) 200 can be separate modules that can be disjointed from one another such that the transmitter module(s) 100 and the receiver module(s) 200 can be located next to and include one or more of the other or additional modules 305, 310, 315, 320, and 325 therebetween. In some embodiments, the logging tool 300 can include a transmitter module 100, three receiver modules 200, and at least three other or additional modules, e.g., 310, 315, 320, in an arrangement that separates the transmitter module 100 and each of the receiver modules 200 from one another via one of the additional modules 310, 315, 320.

The other modules 305, 310, 315, 320, and 325 can independently be one or more nuclear measurement tools, one or more sonic measurement tools, one or more magnetic resonance measurement tools, one or more surveying measurement tools, one or more ancillary or adapter head tools, or combinations thereof. The nuclear measurement tool(s) can be configured to obtain measurements that include natural gamma ray, spectral gamma ray, neutron porosity, lithodensity, neutron-gamma density, spectroscopy, X-ray density, pulsed neutron measurements, nuclear magnetic resonance or combinations thereof. The sonic measurement tool(s) can be configured to obtain measurements that include borehole imaging, monopole, dipole, array sonic measurements, or combinations thereof. The surveying measurement tools can include one or more gyroscopes, one or more accelerometers, one or more magnetometers, or combinations thereof. In some embodiments, the logging tool 300 can include, connected in series, a first module 305 at a first or “top” end, a transmitter module 100, a second module 310, a first receiver module 200, a third module 315, a second receiver module 200, a fourth module 320, a third receiver module 200, and a fifth module 325 that can be located at a second or “bottom” end of the logging tool 300.

In some embodiments, the logging tool 300 can also include an electronic system 330. In some embodiments, the electronic system 330 can be located within one or more of the other modules, e.g., 315 as shown. In other embodiments, the electronic system 330 can be located in the transmitter module 100, the receiver module 200, or a completely independent module that can be incorporated into the logging tool 300. In one or more embodiments, the electronic system 330 can include a master clock 335 that can be shared among at least two modules up to all the modules. The master clock can be any appropriate time keeping device such as a real-time clock that can be capable of coordinating data entries across multiple modules. In some embodiments, the master clock can synchronize at least two modules. In a preferred embodiment, the master clock can synchronize all modules. In some embodiments, the electronic system 330 can also include a computation module 340 that can accommodate any positioning of the one or more transmitter modules 100 and the one or more receiver modules 200 setups within the logging tool 300. In some embodiments, the computation module 340 can include a computation algorithm that can accommodate issues such as well curvature, adjusting for doglegs up to about 30 degrees per 100 feet. In some embodiments, the electronic system 330 can also include one or more chips 345, including but limited to field-programmable gate arrays (FPGAs), application specific integrated circuits (ASICs), chiplets, Multi-Chip-Modules, central processing units (CPUs), and/or system-on-chips (SOCs), and the like. In one or more embodiments, the ASIC can include entire microprocessors, memory blocks including read only memory (ROM), random access memory (RAM), erasable programmable read only memory (EPROM), electrically erasable programmable read only memory (EEPROM), flash memory and other building blocks.

The logging tool 300 can have an outer diameter or other outer maximum cross-sectional length that can be small enough for the logging tool 300 to be able to pass through a drill string. It should be understood that the various modules incorporated into the logging tool 300 can have varying outer diameters or other outer maximum cross-sectional lengths between a first end and a second end of each module. It should also be understood that the various modules incorporated into the logging tool 300 can vary with respect to one another. In some embodiments, the various modules incorporated into the logging tool 300 can independently have a diameter or other outer maximum cross-sectional length of less than 2.5 inches, less than 2.4 inches, less than 2.3 inches, less than 2.2 inches, less than 2.1 inches, or less than 2 inches. In other embodiments, the various modules incorporated into the logging tool 300 can each have the same or substantially the same diameter or other outer maximum cross-sectional length, e.g., within +/−10%, +/−5%, or +/−1% of one another.

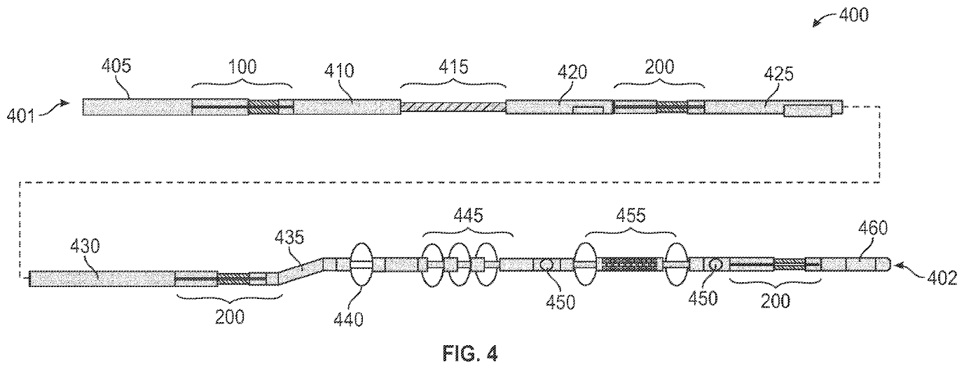

FIG. 4 depicts another illustrative distributed tensor resistivity logging tool 400 for through the drill string conveyance, according to one or more embodiments. In some embodiments, the distributed tensor resistivity logging tool 400 can include a series of tool modules that can be arranged and connected to one another in any order or sequence with respect to one another to form the logging tool 400. In some embodiments, the various tool modules can be or can include, but are not limited to, natural gamma ray modules, spectral gamma ray modules, neutron porosity modules, lithodensity modules, pulsed neutron generator (PNG) spectroscopy porosity modules, knuckles, spacer knuckles, centralizer modules, excentralizer modules, imager modules, dipole sonic modules, induction resistivity modules, or any combination thereof.

As shown in FIG. 4, the logging tool 400 can include, going from a first or “top” end 401 to a second or “bottom” end 402, the following modules connected in series to one another: a natural gamma ray module 405, a transmitter module 100, a spectral gamma ray module 410, an excentralizer module 415, a neutron porosity module 420, a receiver module 200, a lithodensity module 425, a PNG spectroscopy porosity module 430, a transmitter module 100, a spacer knuckle 435, a centralizer module 440, an imager module 445, a first knuckle 450, a dipole sonic module 455, a second knuckle 450, a receiver module 200, and an induction resistivity module 460. It should be understood that the particular arrangement of the modules 405, 410, 415, 420, 425, 430, 435, 440, 445, 450, 455, and 460, the transmitter module(s) 100, and the receiver modules 200 can be arranged in any order or sequence along the length of the logging tool 400. In some embodiments, the transmitter modules 100 are preferably located toward the first or top end 401 of the logging tool 400 and the receiver modules 200 can be located toward the second or bottom end 402 of the logging tool 400 with respect to one another. It should be understood that the logging tool 400 can also include an electronic system 330 as described above with reference to FIG. 3.

The logging tool 400 can have an outer diameter or other outer maximum cross-sectional length that can be small enough for the logging tool 400 to be able to pass through a drill string. It should be understood that the various modules incorporated into the logging tool 400 can have varying outer diameters or other outer maximum cross-sectional lengths between a first end and a second end of each module. It should also be understood that the various modules incorporated into the logging tool 400 can vary with respect to one another. In some embodiments, the various modules incorporated into the logging tool 400 can independently have a diameter or other outer maximum cross-sectional length of less than 2.5 inches, less than 2.4 inches, less than 2.3 inches, less than 2.2 inches, less than 2.1 inches, or less than 2 inches. In other embodiments, the various modules incorporated into the logging tool 300 can each have the same or substantially the same diameter or other outer maximum cross-sectional length, e.g., within +/−10%, +/−5%, or +/−1% of one another.

In some embodiments, a process for conveying the logging tool 300 and/or 400 into a borehole can include conveying the logging tool 300 and/or 400 through a drill string located within the borehole. In some embodiments, the logging tool 300 and/or 400 can be conveyed into and remain within the drill string located within the borehole. In other embodiments, the logging tool 300 and/or 400 can be conveyed into and at least partially extend out of or completely extend out of the drill string and into the borehole. In other embodiments, the logging tool 300 and/or 400 can be conveyed directly into the borehole. For example, the logging tool 300 and/or 400 can be located at the tip or end of a coiled tubing and conveyed directly into the borehole such that the logging tool 300 and/or 400 can be adjacent a borehole wall, e.g., a subterranean formation or a casing disposed within the borehole. In other embodiments, the logging tool 300 and/or 400 can be coupled to a pump down sub (not shown) and wirelessly conveyed into and remain within the drill string located within the borehole or wirelessly conveyed into and at least partially extend out of or completely extend out of the drill string and into the borehole. In one or more embodiments, the logging tool 300 and/or 400 may be wirelessly conveyed into the drill string by pumping against the pump down sub to move the logging tool 300 and/or 400 within the drill string.

In some embodiments, a process for assembling a distributed tensor resistivity logging tool can include serially connecting a plurality of modules to form a distributed tensor resistivity logging tool. The distributed tensor resistivity logging tool can include at least one transmitter module, at least one receiver module, and at least three additional modules connected to one another. At least one of the three additional modules can be located between the at least one transmitter module and the at least one receiver module.

All patents and patent applications, test procedures (such as ASTM methods, UL methods, and the like), and other documents cited herein are fully incorporated by reference to the extent such disclosure can be not inconsistent with this disclosure and for all jurisdictions in which such incorporation can be permitted.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

The foregoing has also outlined features of several embodiments so that those skilled in the art can better understand the present disclosure. Those skilled in the art should appreciate that they can readily use the present disclosure as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that they can make various changes, substitutions, and alterations herein without departing from the spirit and scope of the present disclosure, and the scope thereof can be determined by the claims that follow.

What is claimed is:

1. A distributed tensor resistivity logging tool, comprising:
at least one transmitter module, at least one receiver module, and at least three additional modules connected to one another, wherein at least one of the three additional modules is located between the at least one transmitter module and the at least one receiver module.

2. The distributed tensor resistivity logging tool according to claim 1, wherein the at least three additional modules include one or more nuclear measurement tools, one or more sonic measurement tools, one or more magnetic resonance measurement tools, one or more surveying measurement tools, one or more ancillary or adapter head tools, or combinations thereof.

3. The distributed tensor resistivity logging tool according to claim 2, wherein the at least three additional modules include one or more nuclear measurement tools, wherein the one or more nuclear measurement tools are configured to obtain measurements that include one or more of natural gamma ray, spectral gamma ray, neutron porosity, lithodensity, neutron-gamma density, spectroscopy, X-ray density, pulsed neutron measurements, nuclear magnetic resonance, or combinations thereof.

4. The distributed tensor resistivity logging tool according to claim 2, wherein the at least three additional modules include one or more sonic measurement tools, wherein the one or more sonic measurement tools are configured to obtain measurements that include one or more of borehole imaging, monopole, dipole, array sonic measurements, or combinations thereof.

5. The distributed tensor resistivity logging tool according to claim 2, wherein the at least three additional modules include one or more surveying measurement tools, wherein the one or more surveying measurement tools include one or more gyroscopes, one or more accelerometers, one or more magnetometers, or combinations thereof.

6. The distributed tensor resistivity logging tool according to claim 1, wherein the transmitter module and receiver module are configured to acquire a plurality of full tensor voltage measurements.

7. The distributed tensor resistivity logging tool according to claim 6, wherein the plurality of full tensor voltage measurements are processed through a processor to obtain a full tensor quantity.

8. The distributed tensor resistivity logging tool according to claim 1, wherein the transmitter module and receiver module include a biaxial or a triaxial antenna configuration.

9. The distributed tensor resistivity logging tool according to claim 1, wherein the transmitter module and receiver module include a tool string bus configured to transfer power and electronic communication through the transmitter module and receiver module to additional modules.

10. The distributed tensor resistivity logging tool according to claim 1, wherein the distributed tensor resistivity logging tool comprises a master clock configured to synchronize at least two modules.

11. The distributed tensor resistivity logging tool according to claim 1, wherein the distributed tensor resistivity logging tool comprises a master clock configured to synchronize all modules.

12. The distributed tensor resistivity logging tool according to claim 1, wherein the distributed tensor resistivity logging tool comprises one transmitter module and three receiver modules.

13. The distributed tensor resistivity logging tool according to claim 12, wherein:
the transmitter module and a first of the three receiver modules are separated by a first one of the three additional modules;
the first of the three receiver modules and a second of the three receiver modules are separated by a second one of the three additional modules; and
the second of the three receiver modules and a third of the three receiver modules are separated by a third one of the three additional modules.

14. The distributed tensor resistivity logging tool according to claim 1, wherein the distributed tensor resistivity logging tool has an outer diameter or other outer maximum cross-sectional length sufficiently small such that the distributed tensor resistivity logging tool is capable of being passed through a drill string.

15. A process, comprising:
serially connecting a plurality of modules to form a distributed tensor resistivity logging tool, wherein the distributed tensor resistivity logging tool comprises at least one transmitter module, at least one receiver module, and at least three additional modules connected to one another, wherein at least one of the three additional modules is located between the at least one transmitter module and the at least one receiver module; and
conveying the distributed tensor resistivity logging tool into a drill string within a borehole.

16. The process according to claim 15, wherein the distributed tensor resistivity logging tool is conveyed into the drill string such that the distributed tensor resistivity logging tool remains within the drill string.

17. The process according to claim 15, wherein the distributed tensor resistivity logging tool is conveyed into the drill string such that the distributed tensor resistivity logging tool at least partially extends out of the drill string and into the borehole.

18. The process according to claim 15, wherein the distributed tensor resistivity logging tool is conveyed into the drill string via coiled tubing.

19. The process according to claim 15, further comprising:
coupling a pump down sub to the distributed tensor resistivity logging tool.

20. The process according to claim 19, wherein conveying the distributed tensor resistivity logging tool into a drill string within a borehole comprises pumping against the pump down sub to move the distributed tensor resistivity logging tool within the drill string.
